(19) United States
(12) Patent Application Publication
(10) Pub. No.: US 2016/0333707 A1
(43) Pub. Date: Nov. 17, 2016

(54) TURBO ENGINE ROTOR COMPRISING A BLADE-SHAFT CONNECTION MEANS, AND BLADE FOR SAID ROTOR

(71) Applicant: ANSALDO ENERGIA SWITZERLAND AG, Baden (CH)

(72) Inventors: Steffen HOLZHAEUSER, Nussbaumen (CH); Sinisa Ivkovic, Wettingen (CH); Igor Tsypkaykin, Turgi (CH)

(73) Assignee: ANSALDO ENERGIA SWITZERLAND AG, Baden (CH)

(21) Appl. No.: 15/153,048

(22) Filed: May 12, 2016

(30) Foreign Application Priority Data
May 12, 2015 (EP) 15167350.6

(51) Int. Cl. F01D 5/30; F01D 5/14

(52) U.S. Cl. CPC F01D 5/3007; F01D 5/141; F05D 2240/30; F05D 2240/60; F05D 2250/712; F05D 2250/711

(57) ABSTRACT

In a turbo engine, the rotor includes a shaft, blades, and a shaft-blade connection. The shaft blade connection can be provided as a fir tree connection, having a fir tree blade root and fir tree shaft grooves receiving the blade roots. The blade roots can include lobes, while the grooves can include undercut recesses receiving the lobes. The inclined mating bearing surfaces provided on a shaft post or on a lobe, respectively, are offset with respect to each other in the circumferential direction while partially overlapping. Each bearing surface is tangentially adjoined by a convexly curved end of bedding surface.

### TECHNICAL FIELD

The present disclosure relates to a turbo engine rotor comprising a blade-shaft connection means according to claim 1, and a blade for the turbo engine rotor.

### BACKGROUND OF THE DISCLOSURE

In turbo engines the connection between the rotor shaft and the blades is heavily loaded. In so-called fir tree connections, grooves comprising undercut recesses are arranged in the rotor shaft. Each groove extends radially into the shaft and extends for instance axially, or obliquely, which also comprises an axial extent, and a number of undercut recesses extend along said grooves and extend circumferentially into shaft posts, said shaft posts being formed between the grooves. The undercut recesses are typically tapered, with apexes pointing towards the center of the shaft posts. The blades comprise a corresponding number of lobes provided on and circumferentially extending from blade roots. The blade roots are received within the grooves, with the lobes being received within the undercut recesses. Radially outward pointing walls of the lobes then bear, upon centrifugal loading, on radially inwardly pointing walls of the undercut recesses. It is understood that the terms radially, axially and circumferentially refer to spatial orientations of the turbo engine rotor. The mating walls are inclined with respect to the radial as well as with respect to the circumferential direction of the rotor.

Numerous proposals have been made to improve said fir-tree connections. For instance, GB 2 011 552 discloses a fir tree connection between a blade and a shaft wherein, at an apex of the groove and at a transition between two root lobes, two radii are arranged, wherein a first radius being provided adjacent a load bearing wall is larger than a radius being provided adjacent a non-load bearing wall. Said is intended to improve low cycle fatigue behavior of the components.

However, when the mating surfaces on the blade roots and the shaft are loaded, they deform elastically. In a transitional area between load bearing and non-load bearing surfaces, complex three dimensional material deformations and related local peak stresses are induced. This may result in early fatigue of the blade root-shaft interface.

### LINEOUT OF THE SUBJECT MATTER OF THE PRESENT DISCLOSURE

It is an object of the present disclosure to provide a blade root-shaft interface avoiding local peak loads and related early fatigue.

It is a further object of the present disclosure to avoid abrupt changes in stress related deformation at said interface.

It is still a more specific object of the present disclosure to provide the interface between the blade root and the shaft such that a smooth transition in stress related material deformation is achieved and thus complex local three dimensional stress patterns are avoided.

This is achieved by the subject matter described in claim 1.

More specific embodiments and aspects of the presently disclosed subject matter are set forth in and in connection with the dependent claims.

Further effects and advantages of the disclosed subject matter, whether explicitly mentioned or not, will become apparent in view of the disclosure provided below.

Accordingly, disclosed is a turbo engine rotor comprising a shaft-blade connection means, the rotor having a circumferential direction, a radial direction, and an axial direction defined by a rotor axis. The rotor comprises a rotor shaft and at least one blade. The shaft comprises at least one groove extending from an outer wall of the shaft in the radial direction, towards the center of the shaft, and in the axial direction. Said does not exclude an orientation of the groove oblique to the rotor axis. The blade comprises a root extending in the axial and in the radial direction, wherein the root is arranged in the groove and may thus also be arranged obliquely with respect to the rotor axis. The blade root as well as the counterpart shaft groove may be curved along a lengthwise extent, but may in specific embodiments be straight. At least one undercut recess is provided at the groove and in particular in a shaft post delimiting the groove on one circumferential side. The undercut recess extends in the circumferential direction and is being delimited at a radially outer side by a shaft load bearing wall. The blade root comprises at least one lobe, said lobe in particular being provided on a root body, and said lobe being arranged in the undercut recess, and said lobe being delimited on a radially outer side by a lobe load bearing wall. In typical, however non-limiting, embodiments a number of grooves will be arranged in the circumferential direction around the shaft, and an equal number of blades will be provided in one ring of blades, each root of a blade being arranged in a groove. Shaft posts are present between and circumferentially delimiting neighboring grooves. The undercut recesses are provided on both circumferential sides of the rotor shaft posts. In said embodiments, the grooves may be provided as fir tree grooves and the blade roots may be arranged as mating fir tree roots.

According to the present disclosure, a shaft load bearing wall comprises a plain surface area, said plain surface area being inclined, when seen along the axial direction, with respect to the radial direction at a first angle and forming a shaft load bearing surface. Likewise, the lobe load bearing wall comprises a plain surface area being inclined, when seen along the axial direction, with respect to the radial direction at an at least essentially identical angle, that is, at least essentially at the first angle, and forming a lobe load bearing surface. The lobe load bearing surface and the shaft load bearing surface are provided as mating counterpart surfaces and are offset in the circumferential direction with respect to each other, and moreover overlap along a common circumferential extent. The circumferential direction, as will be readily understood by the skilled person, may in this respect also be referred to as a tangential direction.

The load bearing surfaces provided on a lobe and on the load bearing wall of the respective undercut recess in which the lobe is arranged being mating surfaces means the mating load bearing surfaces are parallel, or, in other words, both are inclined, when seen in the axial direction, at least essentially at the same angle with respect to the radial direction.

It will further be readily appreciated that the groove and the blade root extend along a respective lengthwise orientation. The lengthwise orientation of a groove provided in the shaft and of a mating root will coincide when the root is inserted into the groove. Further, the undercut recesses may in particular comprise a longitudinal extent, said longitudinal extents of the undercut recesses extending along the lengthwise orientation of the respective groove. The lobes arranged on a blade root may in particular comprise a longitudinal extent, wherein said longitudinal extent extends along the lengthwise orientation of the respective groove.

According to another aspect of the present disclosure, there is disclosed a blade for a rotor as described above, the blade comprising an airfoil on a radially outer side of the blade, and a root, wherein the root is adapted and configured to be received within a groove of the shaft of said rotor. The groove comprises at least one undercut recess, comprising at least one plain shaft bearing surface provided on a radially outer wall of said undercut recess pointing radially inwardly and having a circumferential extent. The root of the blade comprises at least one lobe being adapted and configured to be received within said undercut recess. In one aspect, the lobe is at least essentially complementary to the undercut recess. The lobe of the blade root comprises a load bearing wall pointing towards the radially outer side of the blade. A plain lobe bearing surface is arranged on the lobe load bearing wall, and is intended as a mating surface with the shaft bearing surface being provided in the respective undercut recess. The lobe bearing surface is arranged and configured to mate with the shaft bearing surface. The lobe bearing surface is arranged on the root of the blade, or on the lobe load bearing wall, respectively, such as to be circumferentially offset from and partially overlapping with the shaft bearing surface.

In another aspect of the rotor according to the present disclosure, the lobe load bearing surface is circumferentially offset with respect to the mating shaft load bearing surface towards the body of the blade root on which the lobe is provided. That results in the bearing surface being arranged, and in turn the load acting, at a location of the lobe where comparatively more material is present and thus the mechanical strength is comparatively higher. Accordingly disclosed is also a blade as aforementioned, with said offset of the bearing surface being provided towards the body of the root.

In yet another aspect of the rotor as mentioned above, a convexly curved end of bedding surface is provided on the lobe tangentially adjoining the lobe load bearing surface and extending towards an apex of the lobe. Accordingly, a blade for use with this embodiment of the rotor is further characterized in that a convexly curved end of bedding surface tangentially adjoins the lobe bearing surface in a direction towards the lobe tip or apex. Said end of bedding surface is arranged to circumferentially overlap with a section of the counterpart bearing surface of the shaft. To this end, if the lobe and/or shaft bearing surface gets elastically deformed due to the acting centrifugal, or centripetal, respectively, forces acting in the connection means upon operation of the turbo engine, said curved end of bedding surface gradually comes into contact with the counterpart bearing surface provided on the shaft load bearing wall. The deformation, and, accordingly, the stresses in the material, thus only gradually changes over the extent of the end of bedding surface, thus avoiding abrupt gradients of the deformation and material stresses, in turn avoiding inducing complex three dimensional peak stresses, and further in turn resulting to less vulnerability to early low cycle fatigue. The end of bedding surfaces may in particular be provided as cylindrical surface sections, with the respective cylinder axis being parallel to a respective lobe or undercut recess longitudinal extent. The radius of this cylindrical surface may be chosen comparatively large, in order to achieve the smooth transitional deformation area mentioned above. For instance, with the cylinder or end of bedding radius being 50 mm, the respective surface will recede approximately by 1/100 mm for an extent of the end of bedding surface of 1 mm on the lobe and away from the counterpart bearing surface. Choosing the end of bedding radius larger than or equal to 50 mm, and choosing it smaller than or equal to 200 mm, and in particular embodiments smaller than or equal to 100 mm, may prove an appropriate choice.

In further embodiments of the rotor and the blade according to the present disclosure, a further lobe adjoins the lobe radially outwardly. A non load bearing wall of the further lobe adjoins the load bearing wall of the first lobe at a common lobe base. An area of decreasing concave curvature radii is in certain embodiments provided extending from the load bearing surface of the radially inner lobe to the non load bearing surface of the radially outer wall of the radially outwardly arranged lobe. Thus, adjacent the load bearing wall of the first lobe, generally a reduction of notch effects is achieved in providing the comparatively bigger radii, while, due to the smaller radii provided on the non load bearing side of the second lobe, the total height of the blade root is reduced. This results in lower weight of the blade root, and thus in turn in lower mechanical stresses of the entire connection means. This further serves to reduce the vulnerability to low cycle fatigue, and moreover results in increased overspeed safety. Moreover, in reducing the height of the blade roots, with the same number of lobes and thus bearing surfaces being arranged, the grooves in the rotor may be provided with a lower depth, thus providing a mechanically stronger core of the rotor, wherein the core of the rotor is understood as the diametrical section of the rotor in which no attachment means are provided.

The end of bedding surfaces and/or the further convex or concave surface sections may in particular be provided as cylindrical surface sections, with the respective cylinder axis being parallel to a respective lobe or recess longitudinal extent.

According to yet another aspect of the present disclosure, a convexly curved end of bedding surface is provided on the shaft load bearing wall, the end of bedding surface tangentially adjoining the shaft load bearing surface, and in particular being arranged distally from a shaft post. It is understood that also this end of bedding surface overlaps with a part of a counterpart load bearing surface provided on a blade root lobe. This feature provides analogous effects as those described in connection with the end of bedding surface provided adjacent the bearing surfaces of a blade root, or, in combination with an end of bedding surface provided adjacent a mating lobe bearing surface, adds to and amplifies the effect. Abrupt load gradients are thus avoided on the load bearing walls of the root lobe as well as on the load bearing wall of the shaft, and thus local peak stresses which may lead to early fatigue are effectively reduced, if not avoided.

The end of bedding surfaces provided adjacent the shaft load bearing surfaces may in particular be provided as cylindrical surface sections, with the respective cylinder axis being parallel to a respective recess longitudinal extent. The radius of this cylindrical surface may be chosen comparatively large, in order to achieve the smooth transitional deformation area mentioned above. For instance, with the cylinder or end of bedding radius being 50 mm, the respective surface will recline approximately by 1/100 mm for an extent of the end of bedding surface of 1 mm on the wall of the recess and away from the bearing surface. Choosing the end of bedding radius larger than or equal to 50 mm, and choosing it smaller than or equal to 200 mm, and in particular embodiments smaller than or equal to 100 mm, may prove an appropriate choice.

It will be appreciated that in certain embodiments a multitude of fir tree lobes are provided on a root of a blade, and/or a multitude of mating undercut recesses are provided in a groove of the shaft. In particular, the same number of undercut recesses is provided on each circumferential side of the groove, and the same number of lobes is arranged on each lateral side of a mating fir tree blade root. Further, according to specific aspects of the herein disclosed subject matter, a load bearing surface is provided on a radially outer load bearing wall of each undercut recess. A lobe bearing surface may be provided on the radially outer load bearing wall of each lobe. An end of bedding surface may in particular be arranged adjacent each shaft load bearing surface, tangentially adjoining the load bearing surface and in particular distal from a shaft post, or, in other words, adjoining the shaft load bearing surface in a direction towards the center of the groove. Likewise, an end of bedding surface may in particular be arranged adjacent a bearing surface of each lobe, tangentially adjoining the lobe load bearing surface in particular in a direction towards an apex or tip of the lobe.

In further aspects of the presently disclosed subject matter, a groove of the shaft and in particular each groove of the shaft provided in connection with a shaft-blade connection means, is provided as a female fir tree connection feature. A blade root is provided as a male fir tree connection feature

In yet further aspects of the presently disclosed subject matter, at least one pair of lobes is arranged on circumferentially opposed sides of a blade root, and at least one pair of undercut recesses is provided on circumferentially opposed sides of the mating groove, wherein the lobes are arranged in the undercut recesses. Accordingly further disclosed is a blade, wherein the root is a fir tree root comprising at least two pairs of circumferentially opposed lobes, wherein in particular each lobe may be shaped in accordance with the details pertaining to the shape of a lobe lined out above.

In still further embodiments of the herein disclosed rotor, a first height of a lobe measured in the radial direction between a tip of said lobe and a radially outer base of said lobe is larger than a second height of said lobe measured between a tip of said lobe and a radially inner base of said lobe. A first height of an undercut recess measured in the radial direction between a tip of said undercut recess and a radially outer base of said undercut recess may be larger than a second height of said undercut recess measured between a tip of said undercut recess and a radially inner base of said undercut recess. In particular, the first and second heights of a lobe and a respective mating undercut recess may be at least essentially identical. That is to say, the lobes of a blade root are received in mating undercut recesses of the shaft at least essentially without play, at least in the radial direction. To this extent, further disclosed is a blade comprising a root with at least one circumferentially extending lobe, wherein a first height of the lobe measured between a tip of said lobe and a radially outer base of said lobe is larger than a second height of said lobe measured between a tip of said lobe and a radially inner base of said lobe. This may in particular be the case for each lobe provided on the blade root.

Further disclosed is a blade of the type mentioned above, wherein at least two convexly curved surface sections are provided between the lobe load bearing surface and an apex of the lobe, said convexly curved surface sections comprising the end of bedding surface, the end of bedding surface being provided with a first curvature radius, and at least a second convexly curved surface section, said second surface section having a second curvature radius, wherein the second curvature radius is smaller than the first curvature radius, and wherein the curvature radius is decreasing form a convexly curved surface section to a subsequent convexly curved surface section from the lobe load bearing surface to the apex of the lobe. Further convexly curved surface sections may be arranged adjacent the apex of the lobe and towards the non load bearing wall of the lobe, with the radius of curvature being in each case smaller than the radii of curvature of the curved surface sections provided between the apex and the load bearing surface, and/or the radii of curvature of the convexly curved surface sections decreasing with an increasing distance from the apex on the non load bearing side of the lobe. It is understood that said convexly curved surface sections may in particular be part-cylindrical surface sections and may also have either a discrete size along their respective cylindrical circumference, of may also be provided as infinitesimal surface sections. It is understood that in particular the cylinder axes of the respective part cylindrical surfaces may be parallel to the lobe longitudinal extent.

Finally, it will be appreciated that the presently disclosed subject matter generally comprises a blade for a rotor as lined out above, the blade being characterized by the features related to a blade, or a blade root, respectively, disclosed in connection with the rotor.

It is understood that the features and embodiments disclosed above may be combined with each other. It will further be appreciated that further embodiments are conceivable within the scope of the present disclosure and the claimed subject matter which are obvious and apparent to the skilled person.

### BRIEF DESCRIPTION OF THE DRAWINGS

The subject matter of the present disclosure is now to be explained in more detail by means of selected exemplary embodiments shown in the accompanying drawings. The figures show

FIG. 1 a part of a cross section of a turbo engine rotor, including blade-shaft fixation means;

FIG. 2 a blade-shaft fixation means;

FIG. 3 a detail of a blade-shaft fixation means with counterpart bearing surfaces of a lobe and the shaft;

FIG. 4 detail “A” of FIG. 3;

FIG. 5 a first exemplary embodiment of blade root lobes and counterpart shaft recesses;

FIG. 6 a second exemplary embodiment of blade root lobes and counterpart shaft recesses.

It is understood that the drawings are highly schematic, and details, not required for instruction purposes, may have been omitted for the ease of understanding and depiction. It is further understood that the drawings show only selected, illustrative embodiments, and embodiments not shown may still be well within the scope of the herein claimed subject matter.

### EXEMPLARY MODES OF CARRYING OUT THE TEACHING OF THE PRESENT DISCLOSURE

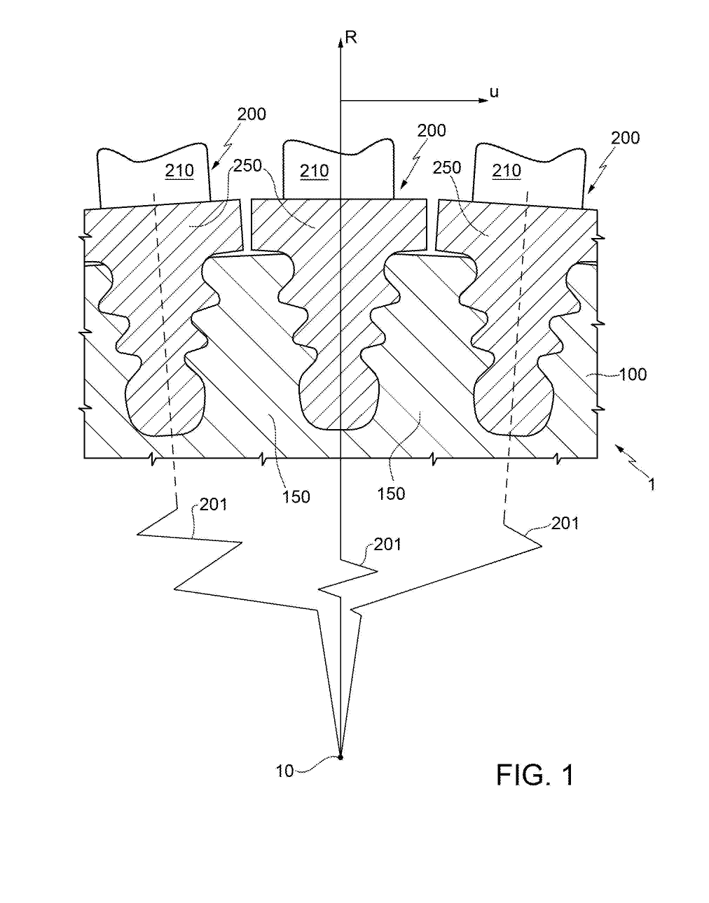

FIG. 1 depicts a part of a cross section of a rotor 1 of a turbo engine. The rotor 1 comprises a rotor axis 10. A radial direction of the rotor is shown at R, a circumferential, or tangential, respectively, direction is shown at U, and an axial direction extends along the rotor axis 10, that is, perpendicular to the drawing plane. The rotor 1 further comprises a rotor shaft 100 and blades 200, attached to the rotor shaft 100 by means of shaft-blade connection means. The blades comprise blade roots 250 provided at a radially inner end of the blades and airfoils 210 provided on a radially outer side of the blades. Each blade has a radial orientation, depicted at 201, defined by the rotor geometry and the intended arrangement of the blades on the rotor. The shaft-blade connection means is provided as a so-called, and well known in the art, fir tree connection. The blade roots are arranged in grooves of the rotor shaft. The grooves are arranged between and circumferentially delimited by shaft posts 150. Each groove extends in the radial direction, i.e. towards the axis 10 of the rotor, and in an axial direction, i.e., along the direction of the rotor axis. As will be lined out in more detail below, undercut recesses are arranged at the grooves and in the shaft posts. Corresponding mating lobes are provided on the blade roots and received in the undercut recesses.

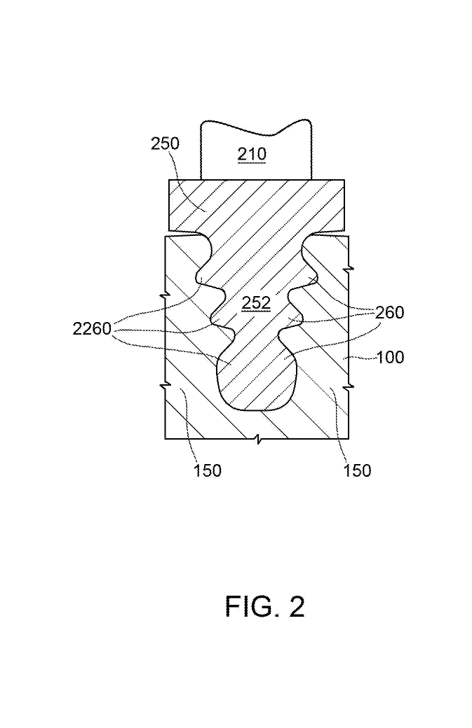

With reference to FIG. 2, a more detailed view of a single shaft-blade connection means of one blade is shown. On a first lateral side of the blade root the lobes 260 are provided. The lobes 260 are arranged in and mating with corresponding recesses provided in the shaft posts 150. On a second lateral side of the blade root 250 lobes 2260 are provided and arranged in recesses of a further rotor post 150. It may be said that the blade root comprises pairs of lobes 260 and 2260 provided on a body 252 of the blade root, on opposing lateral sides thereof, said lobes mating with undercut recesses provided in the shaft posts 150, wherein said shaft posts delimit the groove in which the blade root 250 is arranged.

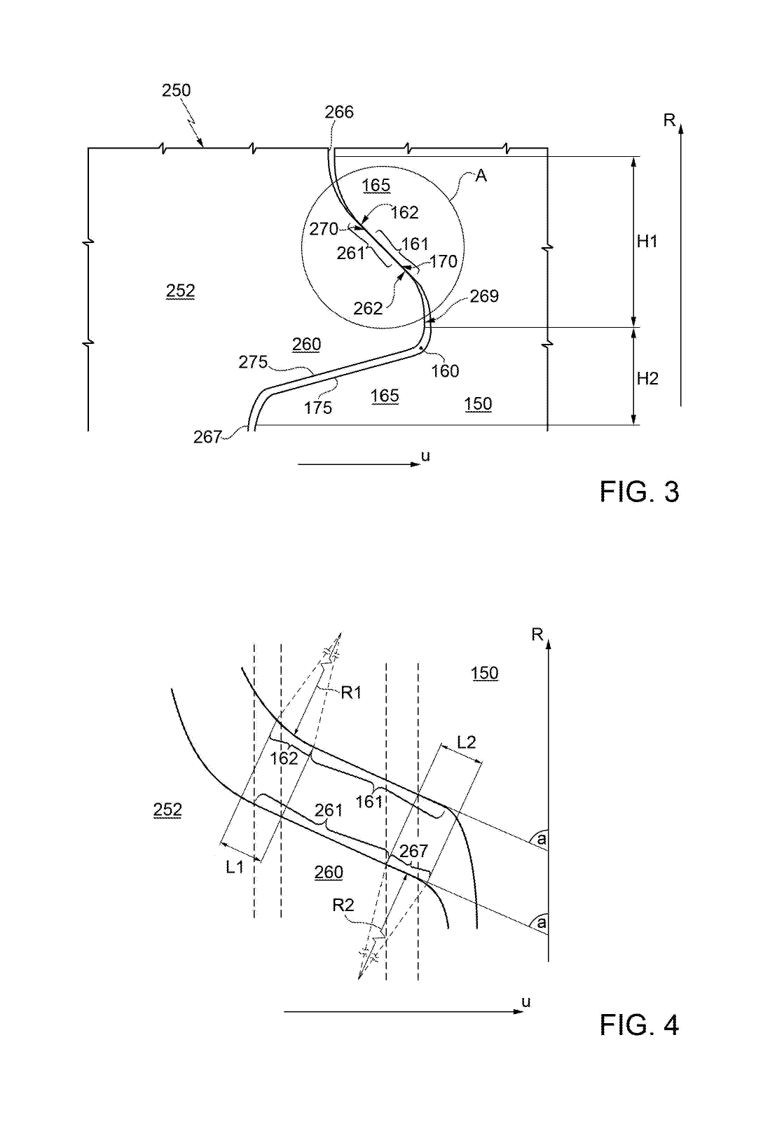

In FIG. 3, a more detailed view of a single lobe 260 of the blade root 250 which is received in a recess 160 provided in a shaft post 150 is shown. The blade root comprises a root body 252 and lobes 260, one of which is shown in the present depiction. The lobe 260 is delimited on a radially outer side by a load bearing wall 270, and is delimited on a radially inner side by a non-load bearing wall 275. The lobe further comprises a tip or apex 269. The lobe may further be said to be limited on a radially outer side by a radially outer base 266 and on a radially inner side by a radially inner base 267. Likewise, the recess 160 is delimited on a radially outer side by a load bearing wall 170, and on a radially inner side by a non-load bearing wall 175. It may also be said, that the recess 160 is delimited in the radial direction by two shaft lobes 165. A shaft bearing surface 161 is provided as a plain surface on the load bearing wall 170. Likewise, a lobe bearing surface 261 is provided as a plain surface on the load bearing wall 270 of the lobe. The load bearing surfaces 161 of the shaft and 261 of the root lobe are offset, while partially overlapping each other, in the circumferential direction U. A convexly shaped end of bedding surface 262 tangentially adjoins the lobe bearing surface 261 and extends from the lobe bearing surface towards the tip 269 of the lobe. A convexly shaped end of bedding surface 162 tangentially adjoins the shaft bearing surface 161 and extends distally from the shaft post 150, or, towards the center of the groove formed between two shaft posts.

Detail A of FIG. 3 is depicted in FIG. 4, with the load bearing surfaces 161 and 261 being shown, for the sake of easier depiction, in a radially diverted state. As is seen, the bearing surface 261 provided on the lobe 260 of the blade root is circumferentially offset with respect to the bearing surface of the shaft 161 towards the body 252 of the blade root. An end of bedding surface 262 tangentially adjoins the bearing surface 261 of the lobe and extends towards the tip of the lobe. The end of bedding surface 262 is for instance a cylindrically curved surface, with a cylinder axis extending parallel to the lobe lengthwise extent and in the particular embodiment parallel to the rotor axis, and having an end of bedding radius R2. Also, an end of bedding surface 162 tangentially adjoins the shaft load bearing surface 161 and extends distally from a body of the shaft post 150. The end of bedding surface 162 is also provided as a convex surface, and may be a part cylindrical surface with the cylinder axis extending along the undercut recess lengthwise extent and in the particular embodiment parallel to the rotor axis. The radius of curvature of the end of bedding surface 162 is denoted at R1. The plane bearing surfaces 161 and 261 are inclined with respect to the radial direction R with at least essentially identical angles a. In other words, they are parallel to each other, and, when mated, are in full surface contact along their circumferentially overlapping sections. The convex end of bedding surface 262 provided on the blade root circumferentially overlaps with a section of the plain bearing surface 161 provided on the load bearing wall of the shaft. The convex end of bedding surface 162 circumferentially overlaps with a section of the plain bearing surface 261 provided on the lobe. Thus, when the load bearing walls of the lobe and of the recess are mated with each other, the end of bedding surfaces 162 and 262 provide a smooth transition area from a contact region of the load bearing surfaces to a gradually receding surface section. The end of bedding radii R1 and R2, respectively, are chosen significantly larger than the widths L1 and L2, respectively, of the end of bedding surfaces. With said widths for instance being one millimeter, and the respective end of bedding curvature radius being for instance 75 millimeters, the maximum arising gap width will be in the region of some microns. Upon loading of the blade-shaft connection due to centrifugal forces acting on the blade, a radially outwardly oriented force acts on the shaft bearing surface 161, while a radially inwardly oriented force acts on the lobe bearing surface 261. In response to these forces, a deformation of the load bearing walls occurs. Due to the presence of the end of bedding surfaces 162 and 262, abrupt deformation gradients and associated peak stresses are effectively avoided. Vulnerability to low cycle fatigue is thus considerably reduced.

Turning now again to FIG. 3, it is moreover seen that the geometry of the load bearing and non-load bearing walls, respectively, is chosen such that a height H1 of the lobe measured between the tip 269 of the lobe and a radially outer lobe base 266 is larger than a height H2 measured between the tip of the lobe and a radially inner base 267 of the lobe. Due to the thus provided geometry, forces acting on the load bearing walls are transposed such that the resulting force vectors are directed towards the massive body 252 of the blade root, or towards the post 150 of the shaft. Shear forces acting on lobes are thus reduced, in turn further enhancing the fatigue strength of the connection means. On the other hand, due to the geometry of the non-load bearing walls, the total height of the connection mechanism is reduced, thus for instance reducing the weight of the blade root and the depth of the counterpart grooves required in the shaft. A reduced weight of the blade roots reduces mechanical stresses induced on the connection means, at the same time improving the safety against overspeed stresses, while the reduced depth of the grooves provided in the shaft enhances the strength of the shaft itself.

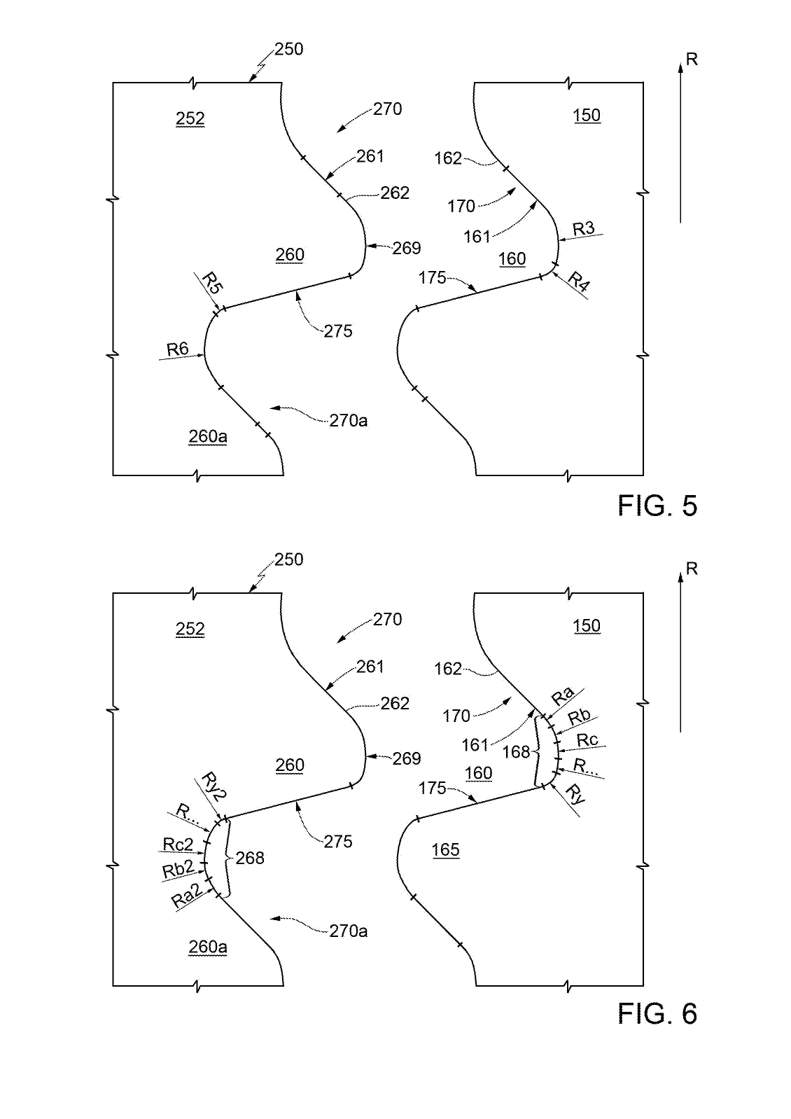

It has become apparent from the description above that on the blade roots as well as on the shaft posts lobes and necks are alternatingly arranged. It is appreciated that due to the alternating arrangement of lobes and necks on the blade roots as well as on the shaft posts notch effects may be present which may tend to weaken the shaft-blade connection means. While increasing the transition radii at those necks may effectively reduce notch effects, said measure is detrimental to the above mentioned goal of reducing the height of the blade roots and the depth of the grooves in the shaft. FIG. 5 depicts an embodiment wherein two radii are applied to span a neck region. On the shaft post 150 side, a load bearing wall 170 and a non-load bearing wall 175 delimit an undercut recess 160. A transitional area between said walls is provided by a concave surface, the neck being defined by said concave surface. Likewise, the shaft root comprises a lobe 260, with a non load bearing wall 275 being provided on a radially inner side. A further lobe 260a is arranged inwardly from the lobe 260, with a load bearing wall 270a being provided on the radially outer side of lobe 260a. A concavely shaped transition surface is provided between the non-load bearing wall 275 of the lobe 260 and the load bearing wall 270a of the lobe 260a. At the shaft post 150 the concave transition area between the load bearing wall 170 and the non-load bearing wall 175 is provided by two radii R3 and R4, with the radius R3, which is arranged adjacent the load bearing wall 170, is larger than the radius R4 which is arranged adjacent the non-load bearing wall 175. In the case of the blade root, radius R5 adjacent the non-load bearing wall 275 is smaller than radius R6 which is located adjacent the load bearing wall 270a. Generally, a larger radius is chosen adjacent a load bearing wall, in order to reduce notch effects and thus improve mechanic strength, while a small radius is chosen adjacent the non-load bearing wall in order to enable a reduced height of the blade root, or depth of the receiving groove, respectively.

FIG. 6 depicts an even more sophisticated embodiment, wherein a multitude of progressively decreasing radii Ra through Ry, or Ra2 through Ry2, respectively, are provided in the concave transition regions 168 on the shaft post and 268 on the blade root.

While the subject matter of the disclosure has been explained by means of exemplary embodiments, it is understood that these are in no way intended to limit the scope of the claimed invention. It will be appreciated that the claims cover embodiments not explicitly shown or disclosed herein, and embodiments deviating from those disclosed in the exemplary modes of carrying out the teaching of the present disclosure will still be covered by the claims.

### LIST OF REFERENCE NUMERALS

1 rotor
10 rotor axis
100 shaft
150 shaft post
160 undercut recess
161 load bearing surface of the shaft
162 end of bedding surface of the wall
165 shaft lobe
168 concavely curved surface section of a shaft post
170 load bearing wall of a shaft recess
175 non load bearing wall of a shaft recess
200 blade
201 blade radial orientation
210 airfoil
250 blade root
252 body of the root
260 lobe of the blade root
261 load bearing surface of a root lobe
262 lobe end of bedding surface
266 base of lobe
267 base of lobe
268 concavely curved surface section of the blade root
269 lobe tip
270 load bearing wall of a root lobe
275 non load bearing wall of a root lobe
260a adjacent lobe
270a load bearing wall of adjacent lobe
2260 lobe on the blade root
a angle formed between a load bearing surface and the radial direction
L1, L2, widths of end of bedding surfaces
R1, R2, end of bedding curvature radii
R3, R4, R5, R6, Ra, Rb, Rc, Ry, Ra2, Rb2, Rc2, Ry2 concave surface section curvature radii
R radial direction
U circumferential direction

1. A turbo engine rotor comprising:
a shaft-blade connection means, the rotor having a circumferential direction, a radial direction, and an axial direction;
a rotor shaft; and
at least one blade, the shaft including at least one groove extending at least in the radial and the axial direction,
the blade including a root extending at least in the axial and in the radial direction,
the root being arranged in the groove,
at least one undercut recess being provided at the groove and in a shaft post, and extending at least in the circumferential direction, the undercut recess being delimited at a radially outer side by a shaft load bearing wall,
the blade root including at least one lobe, said lobe being arranged in the undercut recess, and said lobe being delimited on a radially outer side by a lobe load bearing wall,
wherein the shaft load bearing wall includes a plain surface area being inclined, when seen along the axial direction, with respect to the radial direction at a first angle (a) and forming a shaft bearing surfaced, and
the lobe load bearing wall including a plain surface area being inclined, when seen along the axial direction, with respect to the radial direction at the first angle (a) and forming a lobe bearing surface,
wherein the lobe bearing surface and the shaft bearing surface are offset in the circumferential direction with respect to each other and overlap along a common circumferential extent.

2. The rotor according to claim 1, wherein the lobe bearing surface is circumferentially offset with respect to the mating shaft bearing surface towards a body of the blade root.

3. The rotor according to claim 1, wherein a convexly curved end of a bedding surface is provided on the lobe tangentially adjoining the lobe bearing surface and extending towards a tip of the lobe.

4. The rotor according to claim 1, wherein a concavely curved surface section is provided on the blade root and extending from a lobe load bearing wall to a non-load bearing wall of a lobe, wherein an area of decreasing concave curvature radii (Ra2, Rb2, . . . Ry2) is provided on said concavely curved surface section extending from one lobe load bearing wall to the other lobe non load bearing wall and the radii decreasing from the load bearing wall to the non-load bearing wall.

5. The rotor according to claim 1, wherein a convexly curved end of a bedding surface is provided on the shaft load bearing wall, the end of a bedding surface tangentially adjoining the shaft bearing surface, and is provided distally from a shaft post.

6. The rotor according to claim 1, wherein the groove is provided as a female fir tree connection feature and the blade root is provided as a male fir tree connection feature.

7. The rotor according to claim 1, wherein at least one pair of lobes is provided on circumferentially opposed sides of a body of the blade root, and at least one pair of undercut recesses is provided on circumferentially opposed sides of the groove, wherein the lobes are arranged in the undercut recesses.

8. The rotor according to claim 1, wherein a first height (H1) of a lobe measured in the radial direction between a tip of said lobe and a radially outer base of said lobe is larger than a second height (H2) of said lobe measured between a tip of said lobe and a radially inner base of said lobe, and further a first height of an undercut recess measured in the radial direction between a tip of said undercut recess and a radially outer base of said undercut recess is larger than a second height of said undercut recess measured between a tip of said undercut recess and a radially inner base of said undercut recess, and wherein the first heights of an undercut recess and a respective mating lobe are at least essentially identical and the second heights of an undercut recess and a respective mating lobe are at least essentially identical.

9. A blade for a rotor according to claim 1, the blade comprising:
an airfoil on a radially outer side of the blade, and a root,
the root being adapted and configured to be received within a groove of a shaft of the rotor,
the groove including at least one undercut recess, a plain shaft bearing surface provided on a load bearing radially outer wall of said undercut recess, said shaft bearing surface having a circumferential extent,
the root of the blade including at least one lobe being adapted and configured to be received within said undercut recess,
the lobe having a load bearing wall pointing towards the radially outer side of the blade, and
a plain lobe bearing surface being arranged on the lobe load bearing wall, said lobe bearing surface being arranged and configured to mate with the shaft bearing surface,
wherein the lobe bearing surface is arranged such as to be circumferentially offset from and partially overlapping with the shaft bearing surface.

10. The blade according to claim 9, wherein said offset is provided towards a body of the root.

11. The blade according to claim 9, wherein a convexly curved end of a bedding surface tangentially adjoins the lobe bearing surface in a direction towards the tip of the lobe.

12. The blade according to claim 9, wherein a concavely curved surface extends from the load bearing radially outer wall of a lobe and extends to a non-load bearing radially inner wall of a second lobe, wherein the concavely curved surface includes radii of curvature (Ra2, Rb2, . . . , Ry2) decreasing from the load bearing wall towards the non-load bearing wall.

13. The blade according to claim 9, wherein a first height (H1) of a lobe measured between a tip of said lobe and a radially outer base of said lobe is larger than a second height (H2) of said lobe measured between the tip of said lobe and a radially inner base of said lobe.

14. The blade according to claim 9, wherein at least two convexly curved surface sections are provided between the lobe bearing surface and a tip of the lobe, said convexly curved surface sections including the end of a bedding surface, the end of bedding surface being provided with an end of bedding curvature radius (R2), and at least a second convexly curved surface section, said second surface section having a second curvature radius, wherein the second curvature radius is smaller than the end of bedding curvature radius, and wherein the curvature radius is decreasing from a convexly curved surface section to a subsequent convexly curved surface section from the lobe bearing surface to the tip of the lobe.

15. A blade for a rotor: the blade comprising:
the blade root of claim 1.
